(19) United States
(12) Patent Application Publication
(10) Pub. No.: US 2018/0367820 A1
(43) Pub. Date: Dec. 20, 2018

(54) A CROWD-SOURCED BROADCASTING SYSTEM AND METHOD

(71) Applicant: Faraday&Future Inc., Gardena, CA (US)

(72) Inventor: Abulimiti ABULIKEMU, Beijing (CN)

(73) Assignee: Faraday&Future Inc., Gardena, CA (US)

(21) Appl. No.: 16/060,917

(22) PCT Filed: Dec. 8, 2015
(86) PCT No.: PCT/CN2015/096628

§ 371 Date: Jun. 8, 2018

(51) Int. Cl. H04N 21/2187; H04N 21/2665; H04N 21/2743; H04N 21/4788

(52) U.S. Cl. CPC H04N 21/2187; H04N 21/4788; H04N 21/2743; H04N 21/2665

(57) ABSTRACT

Embodiments of the disclosure are directed to a broadcasting system and method that allows incorporation of user-generated content such as user videos of a live event and user commentary (audio and/or video) about the live event. The live video and audio including the user-generated content can be streamed to users over the internet or via more traditional broadcasting methods such as over-the-air (OTA) broadcast, satellite, cable, etc.

### FIELD OF THE DISCLOSURE

This relates generally to live video, such as live video captured by a mobile device and streamed back to a central server.

### BACKGROUND

Traditionally, live video of an event such as a soccer game is provided by a single broadcasting company. The broadcasting company captures the live action onsite using its camera systems, transmits the captured information to a central server, where the information is edited to produce a live streaming signal to be transmitted over a network (e.g., satellite or internet) to the viewers tuning in to watch the program. This process does not allow the viewers to participate in the filming, editing, or any other part of broadcasting the event.

### SUMMARY

Embodiments of the disclosure are directed to a broadcasting system and method that allows incorporation of user-generated content such as user videos of a live event and user commentary (audio and/or video) about the live event. The live video and audio including the user-generated content can be streamed to users over the internet or via more traditional broadcasting methods such as over-the-air (OTA) broadcast, satellite, cable, etc.

### BRIEF DESCRIPTION OF THE DRAWINGS

FIG. 1 illustrates an exemplary system for streaming video of a live event according to embodiments of the disclosure.

FIG. 2 illustrates an exemplary method of streaming video of a live event according to embodiments of the disclosure.

FIG. 3 illustrates an exemplary system for streaming video of a live event according to embodiments of the disclosure.

FIG. 4 illustrates an exemplary central server according to embodiments of the disclosure.

### DETAILED DESCRIPTION

In the following description of embodiments, reference is made to the accompanying drawings which form a part hereof, and in which it is shown by way of illustration specific embodiments which can be practiced. It is to be understood that other embodiments can be used and structural changes can be made without departing from the scope of the disclosed embodiments.

Traditionally, live video of an event such as a soccer game is provided by a single broadcasting company. The broadcasting company captures the live action onsite using its camera systems, transmits the captured information to a central server, where the information is edited to produce a live streaming signal to be transmitted over a network (e.g., satellite or internet) to the viewers tuning in to watch the program. This process does not allow the viewers to participate in the filming, editing, or any other part of broadcasting the event.

Embodiments of the disclosure are directed to a broadcasting system and method that allows incorporation of user-generated content such as user videos of a live event and user commentary (audio and/or video) about the live event. The live video and audio including the user-generated content can be streamed to users over the internet or via more traditional broadcasting methods such as over-the-air (OTA) broadcast, satellite, cable, etc. This can provide a way for a viewer to customize the video/audio feed of an event rather than having no choice but to accept the feed provided by the broadcasting company.

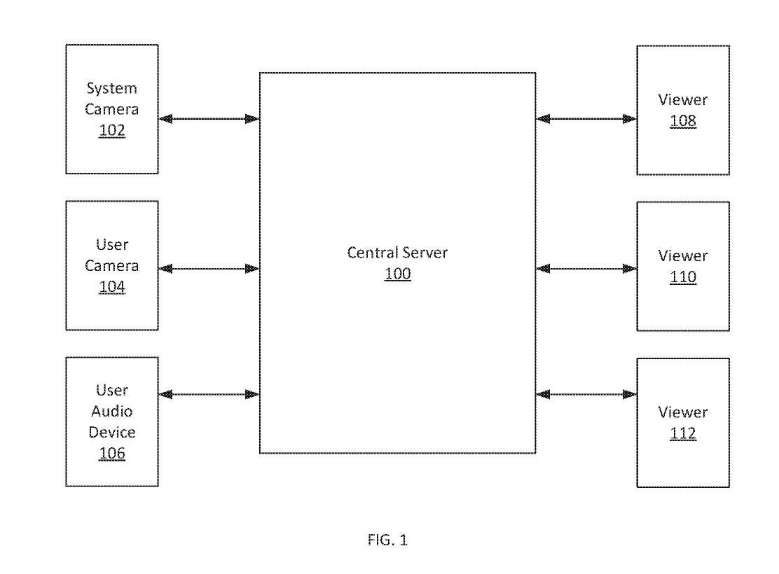

FIG. 1 illustrates an exemplary system for streaming video of a live event according to embodiments of a disclosure. In some embodiments, the broadcasting system can include cameras 102 (e.g., conventional, 3D, 360 degree, etc.) onsite to capture the live action and transmit it to a central server 100. Further, viewers watching the event live can capture the live action using their own cameras 104 and upload their video streams to the central server 100.

The broadcasting system can capture video and/or audio of one or more official commentators in the studio providing live commentary to the event. Additionally or alternatively, third-party or independent commentators may provide their independent live commentary to the event (e.g., with a user camera 104 or a user audio device 106) and upload it to the central server 100. Still additionally or alternatively, viewers watching from home (or anywhere else) can use their camera to provide a running commentary to the event and upload it to the central server.

The central server 100 can offer live streaming of the event as captured by the plurality of cameras including the broadcasting system's cameras 102 and the viewers' cameras 104. The central server can also offer different live commentaries by one or more of the official commentators, independent commentators, and/or viewers. The central server can provide the different views and commentaries via a network (e.g., internet or satellite network) to a viewer's device (e.g., viewer device 108, 110, and/or 112) and allow the viewer to select the view(s) and/or commentaries to watch/listen.

For example, one of the cameras may be following a player on the field at all times. Another camera may provide a 360 degree view of the field. These cameras can be operated automatically or by a cameraman working for the broadcasting company or a viewer watching from the stands. The video captured by both cameras can be transmitted to the central server and made available to the viewers tuning in to the event with or without minimal editing by the central server. Optionally, a location of the camera capturing the video can also be transmitted to the central server. The location can be a particular seat or seating area at the venue of the event being broadcast or any type of geographic coordinates (e.g., GPS coordinates, City/Country). This location information can also be made available to the viewers streaming the event from the central server. Optionally, an identity of the cameraman capturing the video can also be uploaded to the central server to enable the viewers to select a video feed by the person producing the feed. Each viewer can select one or more of these views by, for example, the live pictures provided by these views, the location of the camera, or the identity of the cameraman. For example, a viewer may have two viewing windows on his device, allowing him to both follow the player's action and see the whole field. One of the viewing windows can show a feed provided by the official broadcast of the event while the other window can show a feed from an audience member at the event. Similarly, both windows can show feeds provided by audience members. At any time, the viewer may choose to close one view (or select another view provided by the central server). Generally, the viewer can have as many different feeds of the live event displayed on his terminal as he wishes. This can allow the viewer to experience the event from different viewing perspectives as he wishes.

In some embodiments, a viewer can produce a version of the live event by selecting and editing pictures or clips from the different sources and broadcast the version online. This can be done by defining a beginning and end of a clip from one live feed, adding it to a timeline, and continuously repeating these steps while uploading the edited clip online. Alternatively, a viewer can select the live feed from each individual camera as he prefers it to be presented on his own viewing device. The viewing device may track or monitor his selections, compose a version of the live event accordingly, and transmit the edited stream back to the central server to be broadcasted to other viewers. The viewing device may also transmit the user's selections to the central server, which then composes a version of the live event accordingly to be broadcast to other viewers.

In some embodiments, additional information can be superimposed on the live broadcast. Such information can include, for example, background information of a player, highlights, career stats, etc. In some embodiments, commentaries (e.g., video or textual commentaries) can be superimposed on the live broadcast. The commentaries can be from an official commentator, a person providing a live feed of the event, or any viewer receiving a feed of the event. The commentaries can be in different formats such as, but not limited to, video, audio and text. For example, a viewer can select a feed from the multiple feeds provided by the central server, and then select a line of commentaries to be superimposed on the feed. This can allow the live event to be broadcast in a way that is completely customized by and for the user. Alternatively, the central server can select a line of commentaries based on the video feed(s) the viewer has selected to receive. In one example, the selected line of commentaries can be produced by the same person/source that is also providing the video feed selected by the viewer. Alternatively, the central server can select a line of commentaries based on the viewer's preference as determined by his prior selection of commentaries. For example, the central server can set as the default a line of commentaries provided by a person/source that has been previously selected by the same viewer when watching other events.

In some embodiments, advertisement fees can be collected by a commentator if certain products are mentioned in his commentaries. The central server can determine the advertisement fee a commentator receives based on the popularity of his commentaries (e.g., how many viewers have selected to listen to his commentaries). Additionally or alternatively, the central server can increase the ranking of a commentator among all the commentators covering an event in response to receiving a fee from the commentator. In some embodiments, the central server can use the popularity ranking associated with each commentator to sort the commentaries available to a viewer, such that the most popular commentaries are displayed higher in a list than less popular commentaries.

In addition, the central server may require a viewer to pay a fee to have access to a particular feed from a camera with an excellent view of the field. The central server can provide different views based on different fees received from the viewer. Alternatively, the central server can collect advertisement fees from advertisers on the video feeds from individual cameras according to desirability of the view of the cameras. For example, the central server may place advertisements in the live feed or on images collected by individual cameras. The advertisements may be determined by the central server according to popularity of the views of the cameras. For instance, if the central server determines that a first camera with a particular view is selected by more viewers than a second camera with a different view, the central server may set the advertisement fee for the first camera to an amount greater than the advertisement fee for the second camera.

In addition, the central server may automatically provide advertisement fees to a viewer contributing to the editing of the live feed from the central server. The central server can determine the appropriate advertisement fee based on the popularity of the viewer's version of the live event (e.g., how many other viewers have selected to watch his/her version). Additionally or alternatively, the central server can accept a fee to increase a viewer's ranking (as a contributor/producer/editor) among all the viewers watching the event.

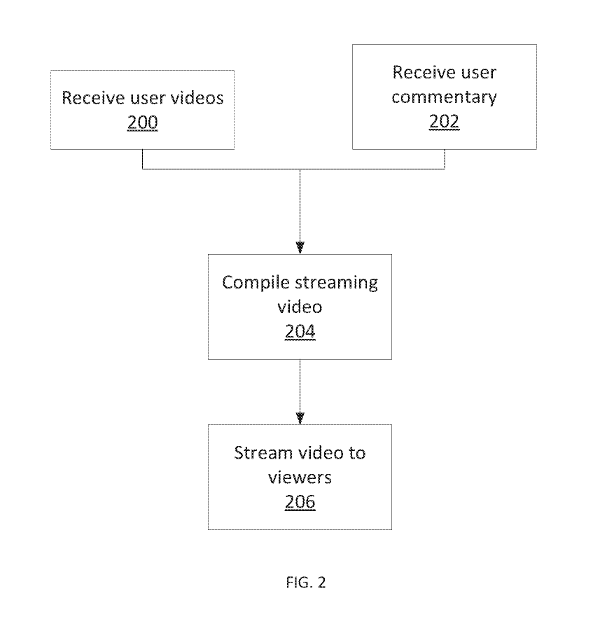

FIG. 2 illustrates an exemplary method of streaming video of a live event according to embodiments of the disclosure. An electronic device (e.g., a central server 100 or another electronic device, such as a computer, a mobile device, and/or a smartphone) can receive (200) a plurality of videos from a plurality of devices located in a geographic region surrounding the live event. In addition, the electronic device can receive (202) user commentary such as a first commentary on the live event. The commentary may be received from a device outside the geographic region surrounding the live event, or from a device with a location inside the geographic region surrounding the live event. Further, the user commentary can include video and/or audio content.

The electronic device can make the plurality of videos available to viewers over a network, and the electronic device can further compile (204) a streaming video based on the user videos and/or the user commentary. The streaming video may be compiled based on receiving a viewer selection of one or more of the plurality of videos. For example, the electronic device can pair the selected one or more videos with audio from the first commentary. In some embodiments, compiling the streaming video may include generating a new video including portions of a first video and a second video of the plurality of videos. In the new video, portions of the first video and the second video may be shown concurrently (e.g., in a split screen format), and/or portions can be shown one after the other in series.

The compiling of the streaming video (e.g., pairing video and audio, generating video including portions of multiple videos, etc.) may be performed by a central server and/or by a user device such as a mobile device, smartphone, laptop, set-top box, etc. In some examples, the central server can provide multiple video feeds/commentaries to a user device, the viewer can select which video feeds/commentaries to view, and the final video is produced by the user device itself based on the selections.

The electronic device can then stream (206) the streaming video of the live event. For example, the video can be streamed to one or more viewers (e.g., to the viewers' computers and/or mobile devices). As discussed above, the streaming video can include one or more of the received plurality of videos and one or more of the received plurality of commentaries.

In some embodiments, the electronic device can receive a request to contribute live video of the event (e.g., from a user device) before the user-generated video is accepted by the electronic device. The electronic device can first verify that the contributed live video is associated with a location within the geographic region surrounding the live event. This can help ensure that the video is in fact coming from the live event. Then, in response to verifying that the contributed live video is associated with a location within the geographic region surrounding the live event, the electronic device can include the contributed live video in the streaming video.

In some embodiments, the electronic device can receive a collection of user-generated content including the plurality of videos and a plurality of commentaries. The electronic device can rank each respective portion of the collection of user-generated content based on a popularity value associated with the respective portion. Then, the electronic device can select a portion of the user-generated content to stream based on the ranking. Each respective portion of the user-generated content can be associated with a respective user that submitted the respective portion, and the popularity value associated with the respective portion can be determined based on a popularity value associated with the respective user. For example, commentaries from a popular user may be ranked more highly than commentaries from a less popular user. Accordingly, when a viewer is selecting commentaries, the commentary from the more popular user may be displayed first in a list of commentaries. In some embodiments, popular commentaries and/or commentaries from popular users may be automatically selected for inclusion in streaming video without the need for a user to select the commentary via user input.

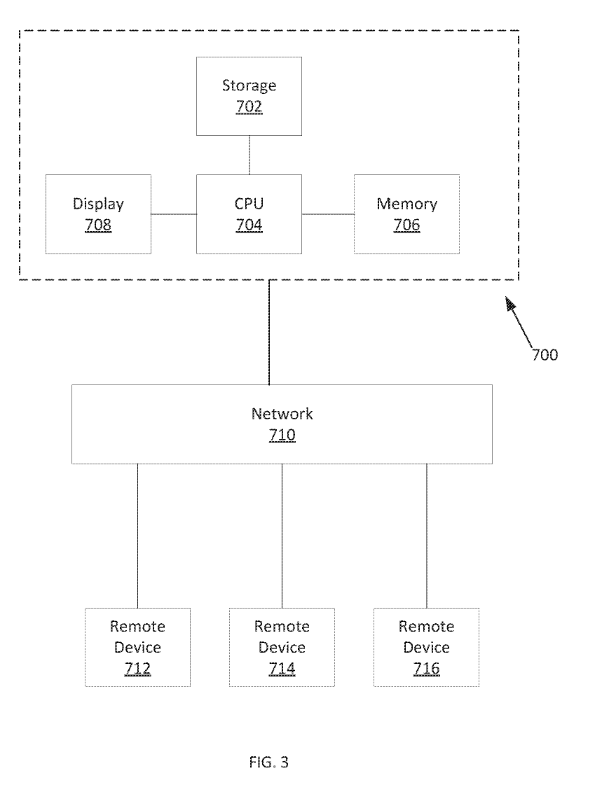

FIG. 3 illustrates an exemplary system 700 for streaming video of a live event according to embodiments of the disclosure. The system 700 can include a CPU 704, storage 702, memory 706, and display 708. The CPU 704 can perform the methods illustrated in and described with reference to FIGS. 1 and 2. Additionally, the storage 702 can store data and instructions for performing the methods illustrated and described with reference to FIGS. 1 and 2. The storage can be any non-transitory computer readable storage medium, such as a solid-state drive or a hard disk drive, among other possibilities. User interfaces, such as a user interface for selecting views and/or commentaries for viewing a live event as described above, may be displayed on the display 708.

The system 700 can communicate with one or more remote devices 712, 714, and 716 (e.g., remote cameras, audio devices, viewers, and/or a central server) over a wired or wireless network 710, such as a local area network, wide-area network, or internet, among other possibilities. The steps of the methods disclosed herein may be performed on a single system 700 or on several systems including the remote devices 712, 714, and 716.

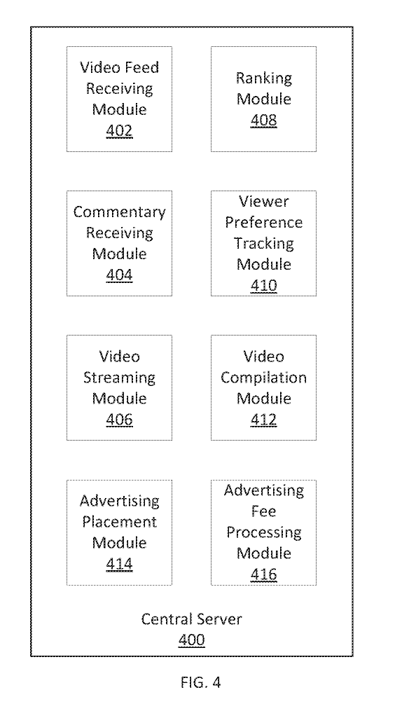

FIG. 4 illustrates a functional block diagram of a central server 400 configured in accordance with the principles of the various described embodiments. The functional blocks of the central server are, optionally, implemented by hardware, software, or a combination of hardware and software to carry out the principals of the various described embodiments. It is understood by persons of skill in the art that the functional blocks described in FIG. 4 are, optionally, combined or separated into sub-blocks to implement the principles of the various described embodiments. Therefore, the description herein optionally supports any possible combination or separation or further definition of the functional blocks described herein.

As shown in FIG. 4, the central server 500 can include a video feed receiving module 402 configured for receiving a plurality of videos from one or more users and/or one or more camera operators associated with a broadcaster. The central server 500 can further include a commentary receiving module 404 configured for receiving a plurality of commentaries (comprising text, audio, and/or video) from one or more users and/or one or more commentators associated with a broadcaster. As discussed above, the video feed and commentary receiving modules can be implemented in software and/or hardware. For example, the receiving modules each may include different software modules for processing the content but both modules may use the same network device(s) as a communication channel, in some embodiments.

The central server 500 can further include a video compilation module 412 configured for compiling video and audio content based on the plurality of videos and commentaries received by modules 402 and 404. The compiling can include pairing audio from one or more commentaries with one or more videos. The compiling can include generating a video including multiple videos, shown concurrently and/or in series. The compiling can include automatic application of basic audio/video editing and processing techniques, such as transitions, crossfading, split-screen, alpha-compositing, overlay of text and/or images, audio equalization/normalization, etc.

The central server 500 can further include a video streaming module 406 configured for streaming video (e.g., any videos received by modules 402 or 404 and/or any videos created by the video compilation module 412) over a network (e.g., the internet, a cellular network, etc.) to users and/or viewers.

The central server 500 can further include a ranking module 408 and/or a viewer preference tracking module 410. The ranking module 408 can be configured to rank portions of user-generated content and/or users that generate the content, and the viewer preference tracking module 410 can be configured to track viewer preferences with respect to user-generated content, such as videos and/or commentaries. Further, the modules 408 and 410 can be in communication. For example, the viewer preference tracking module 410 can be configured to track the popularity of a particular user's videos or commentaries, and that information can be provided to the ranking module 408 to rank that particular user based on the user's popularity. The central server can provide the ranking to viewers, with videos/commentaries from more popular users being ranked higher than videos/commentaries from less popular users.

The central server 500 can further include an advertising placement module 414, and an advertising fee processing module 416. The advertising placement module 414 can be in communication with the video compilation module 412 to place advertisements (video, audio, text, and/or images) as overlays or interstitials within the videos. The placement may be based on information from one or more other modules, such as the viewer preference tracking module 410 (e.g., to place targeted ads selected based on viewer preferences) and/or the ranking module 408 (e.g., to place high-value ads on videos/commentaries from highly ranked users). Further, the advertising fee processing module 416 can be configured to request and accept fees from advertisers (e.g., when an ad from the advertiser is placed in a video by the advertising placement module 414), and/or to pay out some or all of an advertising fee to a user that has contributed a video in which an advertisement is placed.

Although the disclosed embodiments have been fully described with reference to the accompanying drawings, it is to be noted that various changes and modifications will become apparent to those skilled in the art. Such changes and modifications are to be understood as being included within the scope of the disclosed embodiments as defined by the appended claims.

What is claimed is:

1. A method of streaming video of a live event, the method comprising:
receiving a plurality of videos from a plurality of devices located in a geographic region surrounding the live event;
making available the plurality of videos over a network;
receiving a selection selecting one or more of the plurality of videos;
receiving a first commentary on the live event; and
streaming video of the live event including the selected one or more videos and the first commentary.

2. The method of claim 1, the method further comprising:
receiving a request to contribute live video of the event;
verifying that the contributed live video is associated with a location within the geographic region surrounding the live event; and
in response to verifying that the contributed live video is associated with a location within the geographic region surrounding the live event, including the contributed live video in the streaming video.

3. The method of claim 1, wherein a collection of user-generated content includes the plurality of videos and a plurality of commentaries including the first commentary, the method further comprising:
ranking each respective portion of the collection of user-generated content based on a popularity value associated with the respective portion; and
selecting a portion of the user-generated content to stream based on the ranking.

4. The method of claim 3, wherein each respective portion of the user-generated content is associated with a respective user that submitted the respective portion, and the popularity value associated with the respective portion is determined based on a popularity value associated with the respective user.

5. The method of claim 1, the method further comprising:
compiling the streaming video based on user input at a remote device.

6. The method of claim 1, the method further comprising:
compiling the streaming video including pairing the selected one or more videos with audio from the first commentary.

7. The method of claim 1, the method further comprising:
compiling the streaming video including generating a new video including portions of a first video and a second video of the plurality of videos.

8. The method of claim 7, wherein the portions of the first video and the second video are shown concurrently in the new video.

9. The method of claim 1, wherein the first commentary is received from a device outside the geographic region surrounding the live event.

10. The method of claim 1, wherein the first commentary includes only audio content.

11. A non-transitory computer readable medium storing instructions that, when executed by an electronic device including one or more processors, cause the electronic device to perform a method of streaming video of a live event, the method comprising:
receiving a plurality of videos from a plurality of devices located in a geographic region surrounding the live event;
making available the plurality of videos over a network;
receiving a selection selecting one or more of the plurality of videos;
receiving a first commentary on the live event; and
streaming video of the live event including the selected one or more videos and the first commentary.

12. The non-transitory computer readable medium of claim 11, the method further comprising:
receiving a request to contribute live video of the event;
verifying that the contributed live video is associated with a location within the geographic region surrounding the live event; and
in response to verifying that the contributed live video is associated with a location within the geographic region surrounding the live event, including the contributed live video in the streaming video.

13. The non-transitory computer readable medium of claim 11, wherein a collection of user-generated content includes the plurality of videos and a plurality of commentaries including the first commentary, the method further comprising:
ranking each respective portion of the collection of user-generated content based on a popularity value associated with the respective portion; and
selecting a portion of the user-generated content to stream based on the ranking.

14. The non-transitory computer readable medium of claim 13, wherein each respective portion of the user-generated content is associated with a respective user that submitted the respective portion, and the popularity value associated with the respective portion is determined based on a popularity value associated with the respective user.

15. The non-transitory computer readable medium of claim 11, the method further comprising:
compiling the streaming video based on user input at a remote device.

16. The non-transitory computer readable medium of claim 11, the method further comprising:
compiling the streaming video including pairing the selected one or more videos with audio from the first commentary.

17. The non-transitory computer readable medium of claim 11, the method further comprising:
compiling the streaming video including generating a new video including portions of a first video and a second video of the plurality of videos.

18. The non-transitory computer readable medium of claim 17, wherein the portions of the first video and the second video are shown concurrently in the new video.

19. The non-transitory computer readable medium of claim 11, wherein the first commentary is received from a device outside the geographic region surrounding the live event.

20. An electronic device comprising:
one or more processors; and
a memory;
wherein the memory stores instructions which, when executed by the one or more processors, cause the electronic device to perform a method of streaming video of a live event, the method comprising:
receiving a plurality of videos from a plurality of devices located in a geographic region surrounding the live event;
making available the plurality of videos over a network;
receiving a selection selecting one or more of the plurality of videos;
receiving a first commentary on the live event; and
streaming video of the live event including the selected one or more videos and the first commentary.
